(19) United States
(12) Patent Application Publication
(10) Pub. No.: US 2015/0186898 A1
(43) Pub. Date: Jul. 2, 2015

(54) GENERATING AN OVERALL CONTROL EFFECTIVENESS

(71) Applicant: BANK OF AMERICA CORPORATION, Charlotte, NC (US)

(72) Inventors: Ellen J. Fox, Charlotte, NC (US); Tomy Victor Pathrose, Chennai (IN); Nicola D. Rivera, Charlotte, NC (US)

(73) Assignee: BANK OF AMERICA CORPORATION, Charlotte, NC (US)

(21) Appl. No.: 14/145,969

(22) Filed: Jan. 1, 2014

(51) Int. Cl. G06Q 30/00

(52) U.S. Cl. CPC G06Q 30/018

(57) ABSTRACT

The present invention includes a system for generating an overall control effectiveness. The system comprises: a memory; a processor; and a module stored in memory, executable by a processor, and configured to: receive a service catalog item; process the service catalog item via an electronic workbook; determine an overall control effectiveness based on processing the service catalog item; and assign the determined overall control effectiveness to the service catalog item.

### BACKGROUND

There is a need to manage and assess the quality of a project's controls.

### BRIEF SUMMARY OF THE INVENTION

In some embodiments, a system for generating an overall control effectiveness is provided. The system comprises: a memory; a processor; and a module stored in memory, executable by a processor, and configured to: receive a service catalog item; process the service catalog item via an electronic workbook; determine an overall control effectiveness based on processing the service catalog item; and assign the determined overall control effectiveness to the service catalog item.

In some embodiments, the processing the service catalog item comprises evaluating the service catalog item against at least one a control objective.

In some embodiments, the at least one control objective includes at least one third party guideline, wherein the third party guideline is associated with COBIT.

In some embodiments, the service catalog item is associated with at least one of a project, a project step, a business development operation, a business unit protocol, a business unit procedure, a business unit service, and a business unit metric.

In some embodiments, the electronic workbook comprises at least one of a menu, a table, a list, a map, or a spreadsheet.

In some embodiments, the electronic workbook enables a user to input information associated with the service catalog item via an interface.

In some embodiments, information associated with the service catalog item comprises at least one of an identification number, a grouping, a service name, a description, included activities, a process description, a control objective, a control objective description, a value driver, a control practice, and guidelines associated with a third party.

In some embodiments, processing the at least service catalog item comprises at least one of receiving, generating and analyzing at least a control design and a control effectiveness, wherein the overall control effectiveness is determined based on the control design and the control effectiveness.

In some embodiments, the overall control effectiveness is determined based on additional information, wherein the additional information comprises at least one of an identification number, a grouping, a service name, a description, included activities, a process description, a control objective, a control objective description, a value driver, a control practice, and guidelines associated with a third party.

In some embodiments, the overall control effectiveness is associated with a threshold of quality.

In some embodiments, the electronic workbook comprises means for identifying at least one gap in control associated with the service catalog item.

In some embodiments, the electronic workbook comprises means for recommending the employment of at least one control objective to fill the least one identified gap associated with the service catalog item.

In some embodiments, the electronic workbook comprises a dashboard, wherein the dashboard comprises means for enabling a user to visually navigate the service catalog item and its associated information, control objectives, and third party guidelines.

In some embodiments, processing the service catalog item comprises aligning at least one third party guideline to at least one control objective.

In some embodiments, the system comprises means for enabling a user to add, edit, delete, modify, save, and store at least one of new and existing control objective.

In some embodiments, the system comprises generating a message in response to assigning the overall control effectiveness to the service catalog item.

In some embodiments, the message is transmitted to a second apparatus associated with a user, wherein the user is at least one of a project manager, an internal operations specialist, a process owner, or a member of a quality assurance team associated with a financial institution.

In some embodiments, the overall control effectiveness is used to obtain an advanced certification for adequate service catalog item quality.

In some embodiments, a method for generating an overall control effectiveness is provided. The method comprises: receiving a service catalog item; processing the service catalog item via an electronic workbook; determining an overall control effectiveness based on processing the service catalog item; and assigning the determined overall control effectiveness to the service catalog item.

In some embodiments, a computer program product for control quality verification is provided. The product comprises: a memory; a processor; and a module stored in memory, executable by a processor, and configured to: receive a service catalog item; process the service catalog item via an electronic workbook; determine an overall control effectiveness based on processing the service catalog item; and assign the determined overall control effectiveness to the service catalog item.

### BRIEF DESCRIPTION OF THE DRAWINGS

Having thus described embodiments of the invention in general terms, reference will now be made to the accompanying drawings, where:

FIG. 1 is a general process flow describing a system that manages a framework for control quality verification, in accordance with embodiments of the present invention;

FIG. 2 is a general process flow describing a system for generating an overall control effectiveness, in accordance with embodiments of the present invention;

FIG. 3 is a general process flow describing a system for third party control alignment, in accordance with embodiments of the present invention;

FIG. 4 is a general process flow describing a system for recommending controls, in accordance with embodiments of the present invention;

FIG. 5A is an exemplary user interface for an electronic workbook, in accordance with embodiments of the present invention;

FIG. 5B is an exemplary user interface a the dashboard, in accordance with embodiments of the present invention; and

FIG. 6 is a block diagram illustrating technical components of a system for assessing a project's control quality, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In other embodiments, an “entity” may not be a financial institution.

In some embodiments, a “user” may be an internal operations specialist, a business development operations specialist, a business unit manager, a project manager, a process owner, or a member quality assurance team associated with the entity.

The entity may currently utilize a financial system that enables a user to map, track, and/or assess the quality (e.g., performance, adherence to guidelines, or the like) of a service catalog item (or a project, a process, a production, a phase of production, a control, a control objective, a third party guideline, a business unit procedure, protocol, service, or metric, or the like). In some embodiments, the user may assess the quality of the service catalog item by evaluating the service catalog item against an industry-standard set of guidelines, such as COBIT, guidelines associated with a third party, or internal quality assessment tools, namely control objectives. Adherence to such guidelines and controls may ensure to a high degree of certainty that the service catalog is designed to perform—and therefore will perform with high priority—at satisfactory quality levels.

The present invention may be designed to incorporate third party regulatory guidelines into the entity's existing quality control system. Uniquely, the third party guidelines may be aligned with or correspond to internal quality control objectives so that the third party guidelines serve as a common translation between one or more sets of guidelines or controls within the entity's quality control system. In theory, if a service catalog item's quality is assessed against and adheres to a control objective that is aligned with a third party guideline (which may be, in some embodiments, more stringent than the internal control objective), then with high probability the service catalog item also adheres to the third party guideline, or vice versa.

The purpose of incorporating third party guidelines into the entity's existing quality control system may be to aid in obtaining advanced quality certifications. A certification may be awarded to the entity as a whole or on a per-service-catalog-item basis for achieving or sustaining a predetermined threshold of quality on a service catalog item. With this certification, the entity may prove to its shareholders that a service catalog item is operating in compliance with industry-standard guidelines and regulations, including those associated with a trusted third party. Ultimately, the certification may increase shareholder confidence that the entity is not only producing high quality service catalog items, but also that they are being measured and validated via reputable methods.

The present invention may enable an apparatus (e.g., a computer system) associated with the entity to efficiently assess and control the quality and performance of a service catalog item in a production environment. In some embodiments, a framework may be provided for managing and maintaining satisfactory performance of a service catalog item as a project (or another business development operation) moves through various phases of production. In some embodiments, the framework may define a menu, a table, a list, a map, or, typically, a workbook.

The workbook may embody a spreadsheet that is utilized by the user to assess the service catalog item against one or more internal control objectives and/or third party guidelines. In practice, analyzing information associated with a service catalog item, a control objective, or an aligned third party guideline may enable the user to determine via the workbook that the service catalog item is perhaps suitable for compliance with industry-standard regulations. The service catalog item (or the associated project/business development operation as a whole) may be granted third-party certification based on its compliance with industry-standard third party guidelines. The actual granting of certification may occur via the entity or a third party.

Information associated with a control objective, a service catalog item, or a third party guideline may include an identification number, a grouping, a service name, a description, included activities, or the like and may be used as a reference for alignment. Information associated with the alignment of a control objective to a third party guideline (or vice versa) may be presented in the workbook. This information may include an identification number, a process description, a control objective, a control objective description, a value driver, a control practice, guidelines, or the like. The user may input this information in determining if a control objective or a service catalog item applies to or is aligned with a third party guideline (or vice versa). The user may also denote in the workbook if the aligned control objective or service catalog item is applicable or not applicable to the third party guideline (or vice versa). Based on its applicability, the user may update information associated with the control objective or service catalog item before a quality evaluation. The user may access this information via an interface that is associated with a display, a touchscreen, a keyboard, a mouse, or the like.

The workbook may be further utilized to evaluate the quality of existing internal controls associated with the entity (e.g., control objectives) or third party guidelines. Associated information fields may be presented to the user and may include a description of controls in place, a control type, a control class, a control design, a control effectiveness, or the like. The user typically selects an appropriate response to each of these fields via a drop down list, but other methods of selecting a response may be used as well.

An overall control effectiveness may serve as a rating of the service catalog item's adherence to internal control objectives or third party guidelines. The overall control effectiveness may be automatically determined by the present invention based on the user's selection of a control design and a control effectiveness associated with the service catalog item. Once determined, the overall control effectiveness may be assigned to the service catalog item. Furthermore, determining the overall control effectiveness may reveal gaps in the existing controls in place associated with the service catalog item.

Additional fields for comments may exist in the workbook, including a control rating justification and a control action plan. Comments may or may not be required depending on the user's selections, any provided information, and the overall control effectiveness rating. It is in these comment fields where control gaps may be identified or addressed. For example, the user may input an action plan with a timeline in the control action plan field. The present invention may be configured to automatically generate a list of gaps in existing controls.

The workbook may prompt the user with a list of gaps in existing controls. This list may include recommendations for adding additional control objectives or third party guidelines to the list of existing controls to address any gaps in control quality associated with the service catalog item. Additional control objectives or third party guidelines may be included in or appended to the service catalog, wherein adding the additional control objectives, service catalog items, or third party guidelines includes creating a record of the additional control objectives, service catalog items, or third party guidelines in the service catalog. When additional control objectives or third party guidelines are added to the list of existing controls, the present invention may be configured to automatically implement or include the additional control objectives, service catalog items, or third party guidelines in the control assessment processes. The user may further be prompted for comments directed to whether or not the recommendations will be taken and applied to the project.

Furthermore, the workbook may enable the user to align a control objective to a third party guideline, or vice versa. The workbook, through a series of user prompts and information inputs, may be configured to identify which control objectives and third party guidelines are associated with one another. Identified control objectives may be determined to be a match with other control objectives or third party guidelines. Based on determining a match between the control objective and the third party guideline, the apparatus may assign and align the control objective to the third party guideline. If no match is determined, the present invention may be configured to enable the user to add the control objective or third party guideline to the service catalog for future item matching.

If maintaining a satisfactory level of quality of a service catalog item requires adherence to a particular control objective, the workbook may be configured to assist the user in identifying which third party guideline aligns (or are associated) with the particular control objective. Alternatively, if a service catalog item requires adherence to a third party guideline, the workbook may enable the user to identify which control objective corresponds to the third party guideline. Thus, the workbook aims to ensure that a high level of project quality is maintained throughout a phase of a service catalog item by evaluating and quantifying the quality of the service catalog item.

In some embodiments, the control objective may serve as a translation means between other control objectives or third party guidelines. In other embodiments, third party guidelines may serve as a translation means between control objectives or other third party guidelines. The user may be enabled to select which translation means is used via the interface. The control objective or the third party guideline may be associated with the service catalog item.

The present invention may enable the user to efficiently modify the total number of items in the service catalog. For example, the present invention may be configured to add a new service item to the item catalog, or edit or modify an existing service catalog item so that it fills in identified gaps in the entity's existing quality control processes. The user may also select a service maturity rating for each service catalog item. Furthermore, a metric for each service catalog item may be provided in the workbook. The metric may include the overall control effectiveness for each service catalog item.

The present invention may help streamline the identification of appropriate controls or gaps in controls when maintaining an adequate level of service catalog item quality. Ultimately, the present invention may improve the entity's foundational understanding of their control management system for ensuring service catalog items comply with internal control objectives and third party guidelines, thus increasing probability that the service catalog items (and their associated projects or business unit services) obtain advanced third party certification.

The framework's interface may further include a dashboard from which the user may manage the quality of a service catalog item. In some embodiments, the dashboard may include a visual representation of the project and its associated phases of project execution. For example, a block diagram or a map may depict how each aspect (a deliverable, a production goal or phase, or the like) of the service catalog item is connected. The dashboard may be configured to present to the information associated with the service catalog item, including but not limited to a list of critical elements, a deliverable title, a control objective, a description, a usage, a timeline, a deliverable dependency, an update, a team name or a list of contributors, a status, a link to a deliverable, or the like. The user may better understand how the service catalog item and its associated information are connected to other service catalog items, control objectives, or third party guidelines.

The information included in the dashboard may be sorted or filtered by a variety of criteria including a deliverable title, a date, a description, a usage, an update, a team, a template, a type, or the like. The information may also be edited, modified, deleted, or added by the user. Typically, the user is removed from the execution of the service catalog item itself, such as a member of an internal quality assurance team. If the user is directly associated with the service catalog item, such as a project manager or a developer, he or she may not have access to edit, modify, add, or delete information.

In some embodiments, the apparatus may transmit a message to the user in response to assessing the quality of the service catalog item, determining the overall control effectiveness, or another function. The message may include a notification that the quality assurance evaluation process is completed, that a particular threshold of quality has been approached or surpassed, that there are identified control gaps, or in response to another action.

All in all, the purpose of the framework (the workbook and the interface) may be to ensure a desired level of quality throughout the various phases of a service catalog item. By evaluating service catalog item quality based on internal control objectives and industry-standard third party guidelines, the framework can increase efficiency in the entity's project execution processes. Furthermore, an easy-to-navigate dashboard and innovative quality assessment tools may simplify the management of the project.

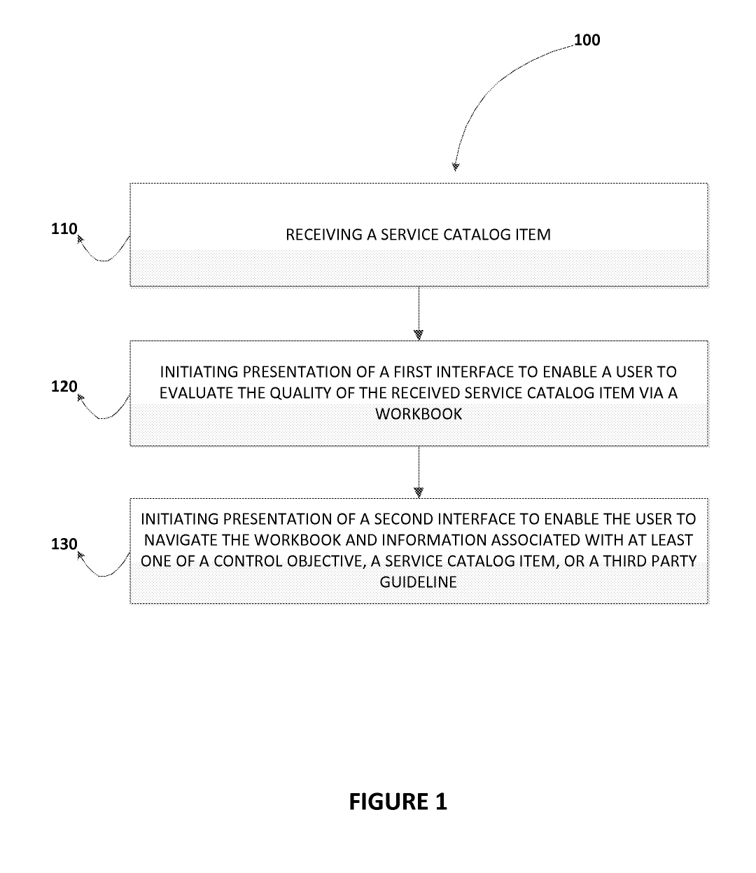

FIG. 1 presents a process flow 100 describing a system that manages a framework for control quality verification. At block 110, the process includes receiving a service catalog item. At block 120, the process includes initiating presentation of a first interface to enable the user to evaluate the quality of the service catalog item via a workbook. At block 130, the process includes initiating presentation of a second interface to enable the user to navigate the workbook and information associated with at least one of a control objective, a service catalog item, and a third party guideline.

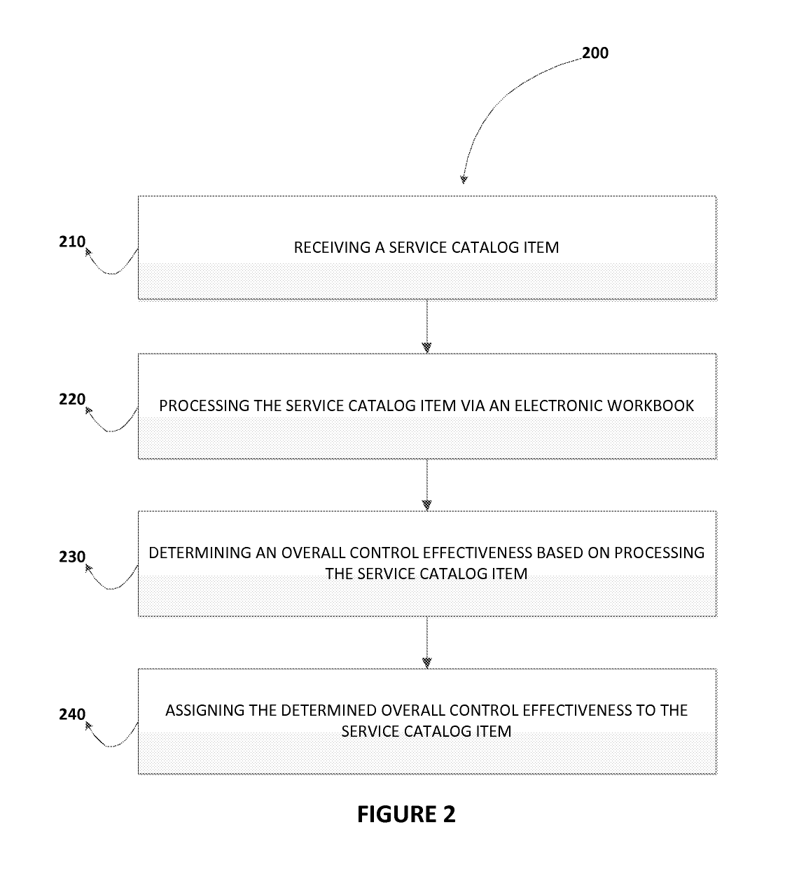

FIG. 2 presents a process flow 200 describing a system for generating an overall control effectiveness for a service catalog item. At block 210, the process includes receiving a service catalog item. At block 220, the process includes processing the service catalog item via an electronic workbook. At block 230, the process includes determining an overall control effectiveness based on processing the service catalog item. At block 240, the process includes assigning the determined overall control effectiveness to the service catalog item.

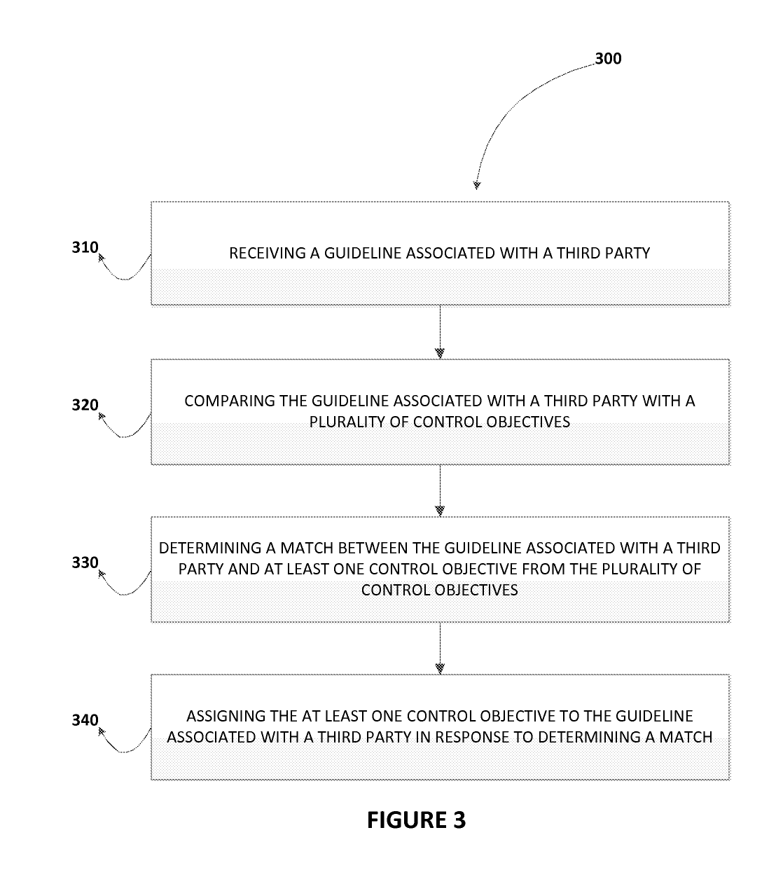

FIG. 3 presents a process flow 300 describing a system for third party control alignment. At block 310, the process includes receiving a guideline associated with a third party. At block 320, the process includes comparing the guideline associated with a third party with a plurality of control objectives. At block 330, the process includes determining a match between the guideline associated with a third party and at least one control objective from the plurality of control objectives. At block 340, the process includes assigning the at least one control objective to the received at least one guideline associated with a third party in response to determining a match.

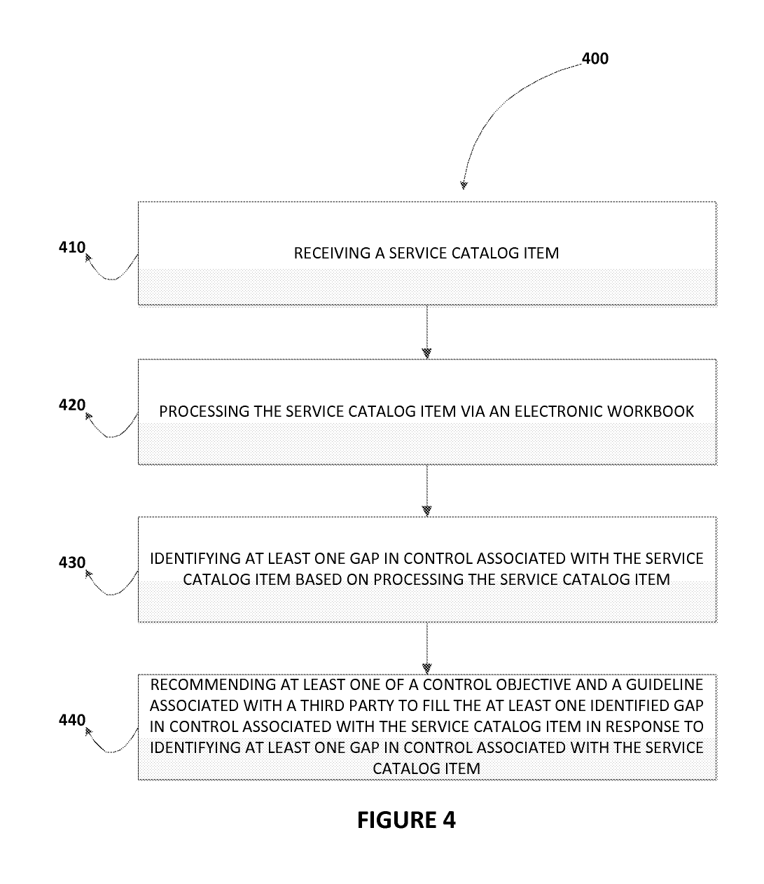

FIG. 4 presents a process flow 400 describing a system for recommending controls. At block 410, the process includes receiving a service catalog item. At block 420, the process includes processing the service catalog item via an electronic workbook. At block 430, the process includes identifying at least one gap in control associated with the service catalog item based on processing the service catalog item. At block 440, the process includes recommending at least one of a control objective and a guideline associated with a third party to fill the at least one identified gap in control associated with the service catalog item in response to identifying at least one gap in control associated with the service catalog item.

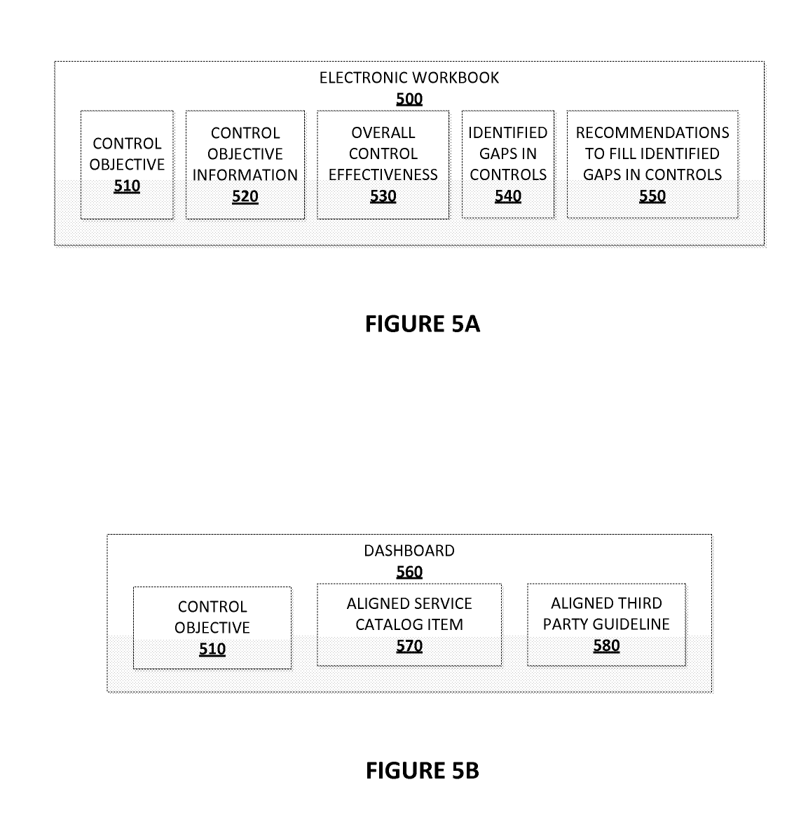

FIG. 5A presents a user interface 500 for the electronic workbook. Block 510 illustrates a control objective. In some embodiments, the control objective 510 may represent a service catalog item or a third party guideline (e.g., COBIT or SAP). In other embodiments, a plurality of control objectives may be presented in the electronic workbook 500. Block 520 illustrates information associated with the control objective, which may include but is not limited to an identification number, a grouping, a service name, a description, included activities, a process description, a control objective, a control objective description, a value driver, a control practice, guidelines, or the like. Block 530 illustrates an overall control effectiveness, which may embody a proprietary quality score. The overall control effectiveness 530 may be generated based on control objective information 520. Block 540 illustrates identified gaps in controls. Gaps in controls 540 may be identified based on control objective information 520. Block 550 illustrates recommendations to fill in the identified gaps in controls 540. The recommendations 550 may include adding or editing an additional control objective, a service catalog item, or a third party guideline to the existing controls.

FIG. 5B presents a user interface 560 for the dashboard. In some embodiments, the dashboard may include a menu or a map for managing and assessing the project's quality. The dashboard may further display to the user any service catalog items 570 or third party guidelines 580 associated or aligned with the control objective 510. In other embodiments, selecting the control objective 510 from the dashboard 560 may open the electronic workbook 500 for processing of the selected control objective or display of its associated information 520. One or more control objectives 510 may be displayed in the dashboard 560.

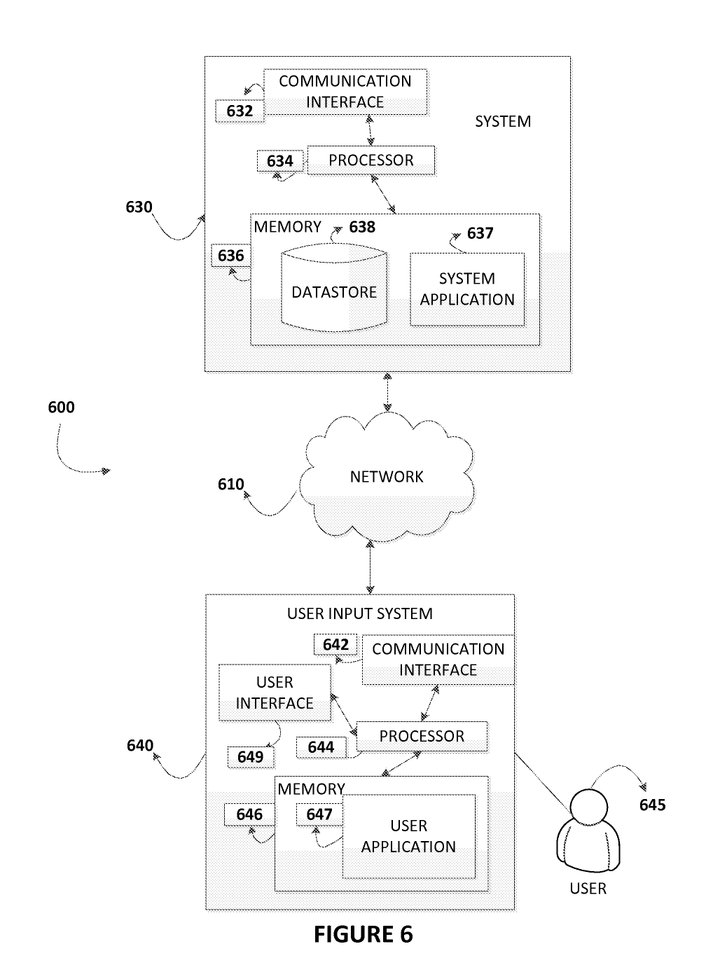

FIG. 6 presents an exemplary block diagram of the system environment 600 for implementing the process flows described in FIGS. 1 through 4 in accordance with embodiments of the present invention. As illustrated, the system environment 600 includes a network 610, a system 630, and a user input system 640. Also shown in FIG. 6 is a user 645 of the user input system 640. The user input system 640 may be a mobile device or other non-mobile computing device. The user 645 may be a person who uses the user input system 640 to execute a user application 647. The user application 647 may be an application to communicate with the system 630, perform a transaction, input information onto a user interface presented on the user input system 640, or the like. The user application 647 and/or the system application 637 may incorporate one or more parts of any process flow described herein.

As shown in FIG. 6, the system 630, and the user input system 640 are each operatively and selectively connected to the network 610, which may include one or more separate networks. In addition, the network 610 may include a telecommunication network, local area network (LAN), a wide area network (WAN), and/or a global area network (GAN), such as the Internet. It will also be understood that the network 610 is secure and may also include wireless and/or wireline and/or optical interconnection technology.

The user input system 640 may include any computerized apparatus that can be configured to perform any one or more of the functions of the user input system 640 described and/or contemplated herein. For example, the user 645 may use the user input system 640 to transmit and/or receive information or commands to and from the system 630. In some embodiments, for example, the user input system 640 may include a personal computer system (e.g. a non-mobile or non-portable computing system, or the like), a mobile computing device, a personal digital assistant, a mobile phone, a tablet computing device, a network device, and/or the like. As illustrated in FIG. 6, in accordance with some embodiments of the present invention, the user input system 640 includes a communication interface 642, a processor 644, a memory 646 having an user application 647 stored therein, and a user interface 649. In such embodiments, the communication interface 642 is operatively and selectively connected to the processor 644, which is operatively and selectively connected to the user interface 649 and the memory 646. In some embodiments, the user 645 may use the user application 647 to execute processes described with respect to the process flows described herein. Specifically, the user application 647 executes the process flow described in FIGS. 1 through 4.

Each communication interface described herein, including the communication interface 642, generally includes hardware, and, in some instances, software, that enables the user input system 640, to transport, send, receive, and/or otherwise communicate information to and/or from the communication interface of one or more other systems on the network 610. For example, the communication interface 642 of the user input system 640 may include a wireless transceiver, modem, server, electrical connection, and/or other electronic device that operatively connects the user input system 640 to another system such as the system 630. The wireless transceiver may include a radio circuit to enable wireless transmission and reception of information. Additionally, the user input system 640 may include a positioning system. The positioning system (e.g. a global positioning system (GPS), a network address (IP address) positioning system, a positioning system based on the nearest cell tower location, or the like) may enable at least one of the user input system 640 or an external server or computing device in communication with the user input system 640 to determine the location (e.g. location coordinates) of the user input system 640.

Each processor described herein, including the processor 644, generally includes circuitry for implementing the audio, visual, and/or logic functions of the user input system 640. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 647 of the memory 646 of the user input system 640.

Each memory device described herein, including the memory 646 for storing the user application 647 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 6, the memory 646 includes the user application 647. In some embodiments, the user application 647 includes an interface for communicating with, navigating, controlling, configuring, and/or using the user input system 640. In some embodiments, the user application 647 includes computer-executable program code portions for instructing the processor 644 to perform one or more of the functions of the user application 647 described and/or contemplated herein. In some embodiments, the user application 647 may include and/or use one or more network and/or system communication protocols.

Also shown in FIG. 6 is the user interface 649. In some embodiments, the user interface 649 includes one or more output devices, such as a display and/or speaker, for presenting information to the user 645. In some embodiments, the user interface 649 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 645. In some embodiments, the user interface 649 includes the input and display devices of a mobile device, which are operable to receive and display information.

FIG. 6 also illustrates a system 630, in accordance with an embodiment of the present invention. The system 630 may refer to the “apparatus” described herein. The system 630 may include any computerized apparatus that can be configured to perform any one or more of the functions of the system 630 described and/or contemplated herein. In accordance with some embodiments, for example, the system 630 may include a computer network, an engine, a platform, a server, a database system, a front end system, a back end system, a personal computer system, and/or the like. Therefore, the system 630 may be a server managed by the entity. The system 630 may be located at the facility associated with the entity or remotely from the facility associated with the entity. In some embodiments, such as the one illustrated in FIG. 6, the system 630 includes a communication interface 632, a processor 634, and a memory 636, which includes a system application 637 and a datastore 638 stored therein. As shown, the communication interface 632 is operatively and selectively connected to the processor 634, which is operatively and selectively connected to the memory 636.

It will be understood that the system application 637 may be configured to implement any one or more portions of the various user interfaces and/or process flow described herein. The system application 637 may interact with the user application 647. It will also be understood that, in some embodiments, the memory includes other applications. It will also be understood that, in some embodiments, the system application 637 is configured to communicate with the datastore 638, the user input system 640, or the like.

It will be further understood that, in some embodiments, the system application 637 includes computer-executable program code portions for instructing the processor 634 to perform any one or more of the functions of the system application 637 described and/or contemplated herein. In some embodiments, the system application 637 may include and/or use one or more network and/or system communication protocols.

In addition to the system application 637, the memory 636 also includes the datastore 638. As used herein, the datastore 638 may be one or more distinct and/or remote datastores. In some embodiments, the datastore 638 is not located within the system and is instead located remotely from the system. In some embodiments, the datastore 638 stores information or data described herein.

It will be understood that the datastore 638 may include any one or more storage devices, including, but not limited to, datastores, databases, and/or any of the other storage devices typically associated with a computer system. It will also be understood that the datastore 638 may store information in any known way, such as, for example, by using one or more computer codes and/or languages, alphanumeric character strings, data sets, figures, tables, charts, links, documents, and/or the like. Further, in some embodiments, the datastore 638 may include information associated with one or more applications, such as, for example, the system application 637. It will also be understood that, in some embodiments, the datastore 638 provides a substantially real-time representation of the information stored therein, so that, for example, when the processor 634 accesses the datastore 638, the information stored therein is current or substantially current.

It will be understood that the embodiment of the system environment illustrated in FIG. 6 is exemplary and that other embodiments may vary. As another example, in some embodiments, the system 630 includes more, less, or different components. As another example, in some embodiments, some or all of the portions of the system environment 600 may be combined into a single portion. Likewise, in some embodiments, some or all of the portions of the system 630 may be separated into two or more distinct portions.

In addition, the various portions of the system environment 600 may be maintained for and/or by the same or separate parties. It will also be understood that the system 630 may include and/or implement any embodiment of the present invention described and/or contemplated herein. For example, in some embodiments, the system 630 is configured to implement any one or more of the embodiments of the process flows described and/or contemplated herein in connection any process flow described herein. Additionally, the system 630 or the user input system 640 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for generating an overall control effectiveness, the system comprising:
a memory;
a processor; and
a module stored in memory, executable by a processor, and configured to:
receive a service catalog item;
process the service catalog item via an electronic workbook;
determine an overall control effectiveness based on processing the service catalog item; and
assign the determined overall control effectiveness to the service catalog item.

2. The system of claim 1, wherein the processing the service catalog item comprises evaluating the service catalog item against at least one a control objective.

3. The system of claim 2, wherein the at least one control objective includes at least one third party guideline, wherein the third party guideline is associated with COBIT.

4. The system of claim 1, wherein the service catalog item is associated with at least one of a project, a project step, a business development operation, a business unit protocol, a business unit procedure, a business unit service, and a business unit metric.

5. The system of claim 1, wherein the electronic workbook comprises at least one of a menu, a table, a list, a map, or a spreadsheet.

6. The system of claim 1, wherein the electronic workbook enables a user to input information associated with the service catalog item via an interface.

7. The system of claim 6, wherein information associated with the service catalog item comprises at least one of an identification number, a grouping, a service name, a description, included activities, a process description, a control objective, a control objective description, a value driver, a control practice, and guidelines associated with a third party.

8. The system of claim 1, wherein processing the at least service catalog item comprises at least one of receiving, generating and analyzing at least a control design and a control effectiveness, wherein the overall control effectiveness is determined based on the control design and the control effectiveness.

9. The system of claim 8, wherein the overall control effectiveness is determined based on additional information, wherein the additional information comprises at least one of an identification number, a grouping, a service name, a description, included activities, a process description, a control objective, a control objective description, a value driver, a control practice, and guidelines associated with a third party.

10. The system of claim 1, wherein the overall control effectiveness is associated with a threshold of quality.

11. The system of claim 1, wherein the electronic workbook comprises means for identifying at least one gap in control associated with the service catalog item.

12. The system of claim 1, wherein the electronic workbook comprises means for recommending the employment of at least one control objective to fill the least one identified gap associated with the service catalog item.

13. The system of claim 1, wherein the electronic workbook comprises a dashboard, wherein the dashboard comprises means for enabling a user to visually navigate the service catalog item and its associated information, control objectives, and third party guidelines.

14. The system of claim 1, wherein processing the service catalog item comprises aligning at least one third party guideline to at least one control objective.

15. The system of claim 1 comprises means for enabling a user to add, edit, delete, modify, save, and store at least one of new and existing control objective.

16. The system of claim 1, wherein the system comprises generating a message in response to assigning the overall control effectiveness to the service catalog item.

17. The system of claim 16, wherein the message is transmitted to a second apparatus associated with a user, wherein the user is at least one of a project manager, an internal operations specialist, a process owner, or a member of a quality assurance team associated with a financial institution.

18. The system of claim 1, wherein the overall control effectiveness is used to obtain an advanced certification for adequate service catalog item quality.

19. A method for generating an overall control effectiveness, the method comprising:
receiving a service catalog item;
processing the service catalog item via an electronic workbook;
determining an overall control effectiveness based on processing the service catalog item; and
assigning the determined overall control effectiveness to the service catalog item.

20. A computer program product for control quality verification, the product comprising:
a memory;
a processor; and
a module stored in memory, executable by a processor, and configured to:
receive a service catalog item;
process the service catalog item via an electronic workbook;
determine an overall control effectiveness based on processing the service catalog item; and
assign the determined overall control effectiveness to the service catalog item.
